(19) United States
(12) Patent Application Publication
(10) Pub. No.: US 2009/0165332 A1
(43) Pub. Date: Jul. 2, 2009

(54) DRYER ARRANGEMENT

(76) Inventors: Herbert Boden, St. Polten (AT); Robert Attwenger, Wien (AT); Rainer Kloibhofer, Neumarkt (AT)

Correspondence Address: TAYLOR & AUST, P.C., P.O. Box 560, 142. S Main Street, Avilla, IN, 46710, US

(21) Appl. No.: 12/393,544

(22) Filed: Feb. 26, 2009

Related U.S. Application Data
(63) Continuation of application No. PCT/EP2007/060955, filed on Oct. 15, 2007.

(30) Foreign Application Priority Data
Oct. 30, 2006 (DE) 10 2006 051 052.6

(51) Int. Cl. F26B 13/14

(52) U.S. Cl. 34/620

(57) ABSTRACT

A dryer arrangement for drying a paper-, cardboard-, tissue- or other fibrous web in a machine for the production and/or conversion of same includes: at least one heated dryer cylinder which is wrapped at least partially by the fibrous web and at least one outer support belt; a pressure hood which impinges the dryer cylinder in the wrap area with a pressurized liquid or gaseous medium, whereby the temperature of the medium is lower than the temperature on the outside of the dryer cylinder in the wrap area; and at least one support belt which is routed over a guide roller immediately prior to and/or after the wrap of the dryer cylinder, the diameter of the dryer cylinder being greater than 1.5 m, the diameter of the guide roller being greater than 400 mm, and the angle of wrap of the support belt being greater than 150°.

### CROSS REFERENCE TO RELATED APPLICATIONS

This is a continuation of PCT application No. PCT/EP2007/060955, entitled “DRYING ARRANGEMENT”, filed Oct. 15, 2007, which is incorporated herein by reference.

### BACKGROUND OF THE INVENTION

1. Field of the Invention

The invention relates to a dryer arrangement for drying a paper-, cardboard-, tissue- or other fibrous web in a machine for the production and/or conversion of same, including at least one heated dryer cylinder which is wrapped at least partially by the fibrous web and at least one outer support belt and including a pressure hood which impinges the dryer cylinder in the wrap area with a pressurized liquid or gaseous medium, whereby the temperature of the medium is lower than the temperature on the outside of the dryer cylinder in the wrap area, and including at least one support belt which is routed over a guide roller immediately prior to and/or after the wrap of the dryer cylinder.

2. Description of the Related Art

The drying of paper webs occurs currently predominantly in dryer groups with heated dryer cylinders.

Since these require a large amount of space there have been efforts for a long time to improve the efficiency of the drying process.

Hence high performance dryer cylinders with increased heat flow through the roll sleeve were developed. These are however subject to relatively high costs and do not permit any substantial increase in consistency of the fibrous web.

The high performance dryer units with pressure hood, as described for example in DE 197 23 163 may provide an increase in the consistency, however causing the load on the belts to be too high.

What is needed in the art is to lessen the load upon the belts in dryer arrangements of this type without detracting from the drying efficiency.

### SUMMARY OF THE INVENTION

The present invention provides that the diameter of the dryer cylinder is larger than 1.5 m, the diameter of the guide roll is larger than 400 mm, and the angle of wrap of the support belt is larger than 150°.

The relatively large dryer cylinder and guide roll diameters ensure a minimum bending load of the belts and at the same time enable a large angle of wrap.

The extended wrap of the dryer cylinder by the fibrous web and the support belt is not only the basis for a long drying distance, but also a minimization of the load upon the dryer cylinder.

Because of the large angle of wrap the resulting load upon the dryer cylinder originating from the pressure of the pressure hood is minimized.

In an effort to keep the bending load on the belts—especially if these are especially thick—as low as possible or, respectively, that the guide roll withstands the high belt pull, it is advantageous if the diameter of the guide roll is greater than 500 mm.

Since the moment of resistance of the dryer cylinder increases with a larger diameter, the diameter of the dryer cylinder should be greater than 2 m, preferably greater than 2.5 m.

Due to the high weight and the roll deflection the inventive advantages come to bear especially with dryer cylinders which are at least 2.5 m long.

Utilization is especially effective when the fibrous web has a dry content between 55 and 80% before it wraps around the dryer cylinder.

Due to the fact that the temperature of the liquid or gaseous medium is lower than the temperature on the outside of the partial circumference of the cylinder around which the material web and support belt wraps, a high level of liquid removal from the fibrous web can be achieved. The support belt and the side of the fibrous web in contact with the support belt are cooled by the medium so that a temperature drop occurs from the heated cylinder in the direction of the support belt.

This increases the heat flow, as well as regulates the direction of the removal of the liquid which discharges from the fibrous web partially as steam. The liquid therefore discharges preferably from the fibrous web on the side which is in contact with the support belt. Due to the cooling of the support belt by way of the medium, the liquid precipitates immediately after its discharge from the fibrous web in the form of condensate onto the support belt and is absorbed by the latter. Due to the cooling of the support belt and the fibrous web, a high dewatering efficiency is achieved, so that the drying performance of the dryer section can be increased while maintaining the same overall length.

Here it is advantageous if an additional second support belt which would preferably have a coarser structure than the first support belt is run around the outside of the cylinder.

The second support belt is routed so that the first support belt is located between the fibrous web and the second support belt. Because the second support belt is cooled immediately by the pressurized medium its temperature is lower than that of the first support belt, so that the liquid emerging in the form of steam from the fibrous web precipitates onto the second support belt in the form of condensate. The steam emerging from the fibrous web initially penetrates the porous first support belt and is then absorbed by the second support belt, so that back-moistening of the fibrous web is practically impossible.

Obviously it is also possible to route more than two support belts, for example three support belts which are cooled by the gaseous or liquid medium around the outside of the cylinder.

The support belts normally have a woven structure. The woven fabric may consist of interwoven threads, for example threads consisting of several individual threads. Relative to the current invention the term “structure” is to be understood to be the woven fabric structure.

This means, a support belt with a coarse structure has larger spaces between the interwoven threads than a support belt having a finer structure whose threads are more closely interwoven. The first support belt with which the fibrous web is in contact therefore is of a finer structure than the second support belt, thereby ensuring that marking of the fibrous web can be avoided.

In addition it is advantageous if an impermeable sealing fabric is run around the outside of the cylinder.

Relative to the current invention “impermeable sealing fabric” is to be understood to be a fabric which is impermeable to fluid and/or gas.

At least one support belt is located between the sealing fabric and the fibrous web which serves to absorb the liquid emerging from the fibrous web. Because of the impermeability of the sealing fabric the pressure of the medium on the outside of the sealing tape can be transferred at a defined rate onto the support belt without the medium being in contact with the fibrous web.

Consequently the fibrous web is pressed onto the circumference of the cylinder, resulting in an increased heat transport from the cylinder to the fibrous web thereby increasing the discharge rate of the liquid from the fibrous web.

In addition the fibrous web is compressed due to medium pressure, and thereby clearly improving its characteristics.

In addition, one embodiment of the dryer arrangement is preferred whereby the first support belt, the second support belt and/or the sealing fabric are routed between the area where the belts/the fabric run off the cylinder and the area were the belts/the fabric run onto the cylinder, outside the pressure chamber of the pressure hood. Easy accessibility to the guide rollers over which the belts run can thereby be ensured. In addition, the design of the pressure hood can be simplified.

Finally, one design example of the dryer arrangement is preferred where the seals, for example sealing strips with which the pressure chamber of the pressure hood can be sealed from the surrounding area conspire with the rolls over which at least one belt and/or the fibrous web is routed, either by being in contact, or not being in contact with said rolls.

In the interest of a simple and space-saving path, the support belt and/or the sealing fabric should be run over at least one guide roll, preferably immediately before or after wrapping the dryer cylinder.

In order to achieve improved drying with the dryer cylinder in contrast to conventional dryer cylinders the roll surface of this dryer cylinder should have a surface temperature of more than 115° C., preferably more than 128° C.

For this purpose the dryer cylinder is heated with a hot fluid, preferably steam, whereby the inside pressure in the fluid chamber of the high performance dryer cylinder is higher than 4 bar, preferably higher than 6 bar.

Depending on the type, basis weight and dry content of the fibrous web it could be advantageous if several dryer arrangements of this type are provided in the dryer section. Other dryer elements could also be located between these dryer arrangements.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 is shows a schematic cross section through the dryer arrangement.

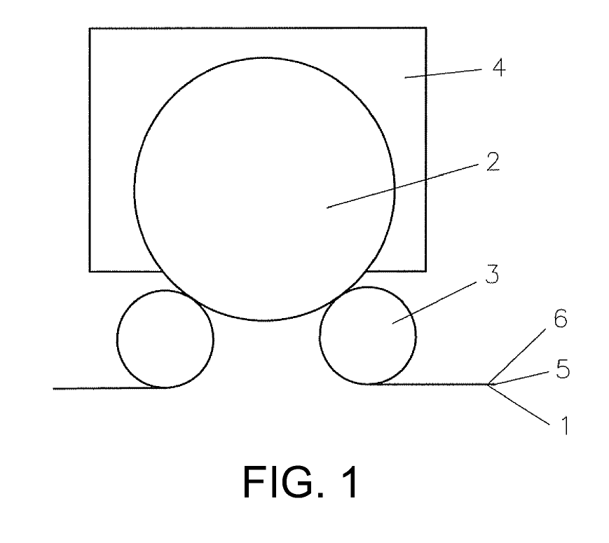

Corresponding reference characters indicate corresponding parts throughout the several views. The exemplification set out herein illustrates one embodiment of the invention, and such exemplification is not to be construed as limiting the scope of the invention in any manner.

### DETAILED DESCRIPTION OF THE INVENTION

Referring now to the drawings, after the fibrous web 1 is heated to a temperature of at least 75° C. it can be fed into a high-performance drying arrangement to intensify the drying and solidification of the fibrous web 1.

In this example this drying arrangement is formed by a heated dryer cylinder 2 which is wrapped by the fibrous web 1 and a support belt 5.

The support belt 5 is porous and water absorbent.

An impermeable sealing fabric 6 is routed around the outside of the dryer cylinder 2 which is impinged upon by a pressure hood with pressurized gaseous or liquid medium.

Here, the pressure hood 4 is depicted opposite the sealing fabric 6.

The medium has a lower temperature than the surface of the dryer cylinder 2 so that a temperature gradient is created between them.

This leads to condensation in the support belt 5 caused by the liquid discharging from the fibrous web 1, as described previously.

The pressure impingement not only improves the contact with the hot cylinder surface, but also leads to solidification of the fibrous web 1, combined with a consistency increase.

The dryer cylinder 2 is longer than 3 m, has a diameter of approx. 2.5 m and is wrapped by the fibrous web 1, the support belt 5 as well as the sealing fabric 6—in this example at an angle of more than 270°.

This large wrap not only provides a long impingement distance for the pressure hood 4, but also a resulting reduced load upon the dryer cylinder 2 caused by the pressure hood 4.

Immediately before and after the wrap the fabrics 5, 6 are run with the fibrous web 1 around a guide roll 3 whose diameter in each instance is more than 500 mm. This relatively large diameter keeps the bending stress on the belts 5, 6 to a minimum.

The drying arrangement requires relatively little space and permits intensive drying. At the start of the high performance drying arrangement the dry content of the fibrous web 1 should be between 55 and 80% in order to utilize the advantages.

Additional belts, which however should possess good heat conducting properties, can also be located, as required, between the fibrous web 1 and the dryer cylinder 2.

Subsequent to the high-performance drying arrangement one can revert to less expensive dryer elements.

The surface of the dryer cylinder 2 has a surface temperature of more than 125° C. Heating occurs through steam whose pressure in the dryer cylinder 2 reaches above 4 bar.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A dryer arrangement for drying a web of fibrous material in a machine for at least one of a production and a conversion of the web, said dryer arrangement comprising:
at least one outer support belt;
at least one heated dryer cylinder including an outside and being configured for being wrapped at least partially by the web and said at least one outer support belt;
a pressure hood which impinges on said at least one heated dryer cylinder in a wrap area with one of a pressurized liquid medium and a pressurized gaseous medium, a temperature of one of said pressurized liquid medium and said pressurized gaseous medium being lower than a temperature on said outside of said at least one heated dryer cylinder in said wrap area;
a guide roller, said at least one outer support belt being routed over said guide roller at least one of immediately prior to and after a wrap of said at least one heated dryer cylinder, a diameter of said at least one heated dryer cylinder being greater than 1.5 m, a diameter of said guide roller being greater than 400 mm, and an angle of wrap of said at least one outer support belt being greater than 150°.

2. The dryer arrangement according to claim 1, wherein said diameter of said guide roller is greater than 500 mm.

3. The dryer arrangement according to claim 1, wherein said diameter of said dryer cylinder is greater than 2 m.

4. The dryer arrangement according to claim 1, wherein said diameter of said dryer cylinder is greater than 2.5 m.

5. The dryer arrangement according to claim 1, wherein a length of said dryer cylinder is at least 2.5 m.

6. The dryer arrangement according to claim 1, wherein prior to wrapping said dryer cylinder the web has a dry content of between 55 and 80%.

7. The dryer arrangement according to claim 1, further comprising at least one additional support belt which runs around said outside of said dryer cylinder.

8. The dryer arrangement according to claim 7, wherein said additional support belt has a coarser structure than said at least one outer support belt.

9. The dryer arrangement according to claim 1, further comprising one impermeable sealing fabric which runs around said outside of said dryer cylinder.

10. The dryer arrangement according to claim 9, wherein at least one of said support belt and said sealing fabric is run over at least one said guide roller one of immediately prior to and after wrapping said dryer cylinder.

11. The dryer arrangement according to claim 1, wherein said dryer cylinder includes a shell which has a surface temperature of more than 115° C.

12. The dryer arrangement according to claim 1, wherein said dryer cylinder includes a shell which has a surface temperature of more than 128° C.

13. The dryer arrangement according to claim 1, wherein said dryer cylinder includes a fluid chamber, said dryer cylinder being heated with a hot fluid, an internal pressure in said fluid chamber of said dryer cylinder being above 4 bar.

14. The dryer arrangement according to claim 1, wherein said dryer cylinder includes a fluid chamber, said dryer cylinder being heated with a hot fluid, an internal pressure in said fluid chamber of said dryer cylinder being above 6 bar.
